(19) United States
(12) Patent Application Publication
(10) Pub. No.: US 2010/0161623 A1
(43) Pub. Date: Jun. 24, 2010

(54) Inverted Index for Contextual Search

(75) Inventor: Oystein Torbjornsen, Trondheim (NO)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/643,588

(22) Filed: Dec. 21, 2009

(30) Foreign Application Priority Data
Dec. 22, 2008 (NO) 2008 5365

(51) Int. Cl. G06F 17/30

(52) U.S. Cl. 707/754; 707/769; 707/E17.014; 707/E17.059

(57) ABSTRACT

In an inverted index for contextual search in a collection of documents is contextual search applied for retrieving one or more tokens of a document as well as the context wherein the one or more tokens occurs, the context being any identifiable structure of a document. Any specific single context forms a scope of the document. The inverted index comprises at least a subindex in the form of a text index of text tokens and the text index comprises field-formatted records including a path field for the path of the scope enclosing the token. The records constitute a posting list of the text index with information of the paths for every occurrence of the tokens. —A path filter for use with the inverted index for contextual search comprises a path pattern in the form of expressions defining which paths that match or do not match a search query.

This application claims benefit of Serial No. 20085365, filed 22 Dec. 2008 in Norway and which application is incorporated herein by reference. To the extent appropriate, a claim of priority is made to the above disclosed application.

### BACKGROUND

The present invention concerns an inverted index for contextual search in a collection of documents, wherein contextual search is applied for retrieving one or more tokens of a document as well as the context wherein the one or more tokens occurs, the context being any identifiable structure of a document; wherein any specific single context forms a scope of the document. The present invention also concerns a path filter for use with the inverted index.

The present invention relates specifically to contextual search in a collection of documents. Contextual search is taken to mean searching for tokens in a collection of documents where the context the tokens occurs in can be used as part of the search expression.

### PRIOR ART

It is common and known in the art for full-text searching to support field names, but this is limited to a flat structure and not hierarchies. For instance see Bast, H., Chitea, A., Suchanek, F., and Weber, I. “ESTER: efficient search on text, entities, and relations” (Proceedings of the 30th Annual international ACM SIGIR Conference on Research and Development in information Retrieval, (Amsterdam, The Netherlands, Jul. 23-27, 2007) SIGIR '07. ACM, New York, N.Y., 671-678). [http://doi.acm.org/10.1145/1277741.1277856].

Zhang, C., Naughton, J., DeWitt, D., Luo, Q., and Lohman, G: “On supporting containment queries in relational database management systems”. (Proceedings of the 2001 ACM SIGMOD international Conference on Management of Data (Santa Barbara, Calif., United States, May 21-24, 2001). T. Sellis, Ed. SIGMOD '01. ACM, New York, N.Y., 425-436. [http://doi.acm.org/10.1145/375663.375722], introduces dual indexes, one for text and one for structure. It does not use paths in either index, but extracts nesting through depth and token position.

Beyer, K., Cochrane, R. J., Josifovski, V., Kleewein, J., Lapis, G., Lohman, G., Lyle, B., Özcan, F., Pirahesh, H., Seemann, N., Truong, T., Van der Linden, B., Vickery, B., and Zhang, C. “System RX: one part relational, one part XML.” (Proceedings of the 2005 ACM SIGMOD international Conference on Management of Data (Baltimore, Md., Jun. 14-16, 2005). SIGMOD '05. ACM, New York, N.Y., 347-358). [http://doi.acm.org/10.1145/1066157.1066197], discloses the use of path identifiers, path directories and Dewey encoding, but does not combine this with inverted indexes.

For overlapping structures most work has been on the XML/SGML notation and query formulation and less on the indexing structures. See for instance GODDAG: A Data Structure for Overlapping Hierarchies CM Sperberg-McQueen, C Huitfeldt—LECTURE NOTES IN COMPUTER SCIENCE, 2004—Springer.

### SUMMARY

In view of some of the deficiencies and disadvantages of the prior art, a main object of the present invention is to provide an index enabling full text search in a document collection with predicates specifying the structure wherein the text occurs and when the structure has overlapping elements.

Another object of the present invention is to enable common features of text searching like relevancy, Boolean operators and phrase searches.

Yet another object of the invention is that search queries not looking for structural elements should be executed with minimal performance impact.

Finally, it is also an object of the present invention to provide a path filter for use with an index enabling full text search in a document collection with predicates specifying the structure wherein the text occurs and when the structure has overlapping elements.

The above objects as well as further features and advantages are realized with an inverted index which comprises a subindex in the form of a text index of text tokens; wherein the text index comprises records formatted with a first field identifying the document wherein the token is located, a second field for the position of the token in this document, and a third field for the path of the scope enclosing the token, and wherein said records constitute a posting list of the text index, such that the index comprises information of the paths for every occurrence of the tokens and hence enables a contextual search.

Also the present invention provides a path filter comprising a path pattern in the form of expressions defining which paths that match or do not match a search query.

In an advantageous embodiment of the invention the inverted index is a dual index comprising in addition to the text index another subindex in the form of a scope index of scopes wherein the text occurs and that the scope index comprises records formatted with a first field for identifying the document wherein the scope is located, a second field for the start position of the scope in that document, a third field for end position of the scope in this document and a fourth field for the path of the scope and always including the scope itself, with said records constituting a posting list of the scope index.

Additional features and advantages will be apparent from the remaining appended dependent claims.

The invention shall be better understood by reading in the following detailed discussion of the realization of the present invention as expressed by a description of the construction of the inverted index and structural features thereof and with reference to the appended drawing figures, of which

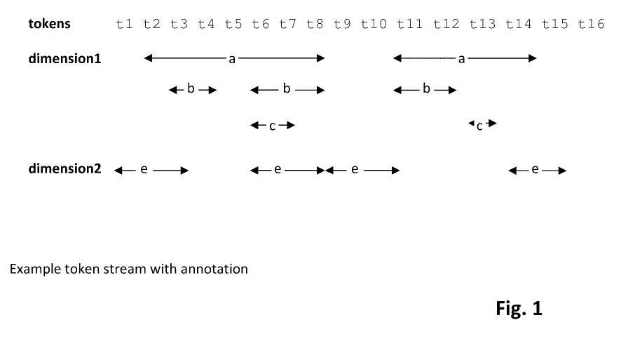

FIG. 1 shows a stream of tokens, the scopes they are occurring in and the dimensions the scopes are located in, and

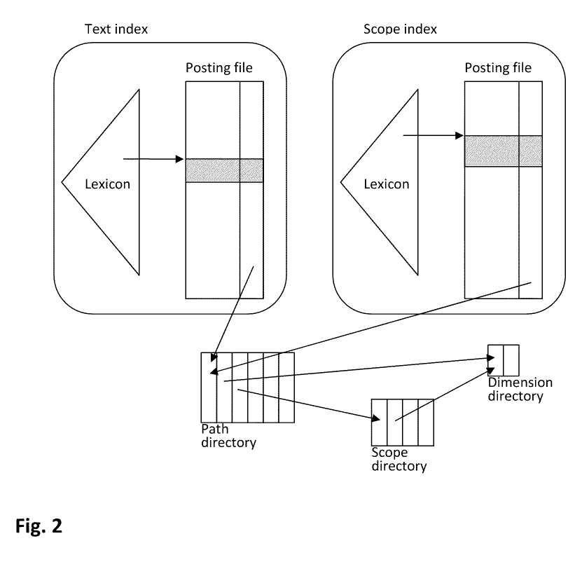

FIG. 2 an overview of a preferred embodiment of the index according to the present invention.

### CONCEPTS AND DEFINITIONS

The term document is used for any type of data file. This can for example be:
a text file like regular unformatted text, HTML, XML, a file produced by text processing software
multimedia data like an image, an audio file, video file
a database record

Documents are uniquely identified with an integer identifier. This identifier is here denoted DocId.

The concept “context” will in this invention be used in the broadest sense. It can be one of the following, but not restricted to:
Structure in the document, e.g. tagging in an XML or HTML document, or fields in a database record.
Textual structure like chapters, sections, paragraphs and sentences.
Layout structure like pages, columns, lines, color and font.
Extracted metadata like person names, company names, addresses, dates, zip codes, prices, URLs, spoken text, subtitles

The term scope denotes one such context, whether it is an XML element, paragraph, line or a name. This invention supports both hierarchical and overlapping scopes. An example of hierarchical scopes can be XML structure or the hierarchy of chapter, section, paragraph and sentence. Sentences and lines are examples of overlapping scopes. A sentence can start in the middle of one line, end in the middle of another and reach over multiple lines in between.

The text in a document is broken into a stream of tokens (for example words, frames and seconds). The tokens are enumerated sequentially. This number is the position. A scope has a defined start (inclusive) and end (exclusive) position.

### EXAMPLE

| 1 | 2 | 3 | 4 | 5 | 6 | 7 | 8 | 9 | 10 | 11 |
|---|---|---|---|---|---|---|---|---|---|---|
| The | Rolling | Stones | have | released | 22 | studio | albums | in | the | UK |

The numbers above the text are the positions. There is one scope called “BandName” (The Rolling Stones) stretching from 1 to 4 and another called “Country” (UK) stretching from 11 to 12.

A scope can have 0 or more named attributes. E.g. a “chapter” can have the attributes “title” (title of the chapter) and “number” (chapter number).

Related scopes are grouped into dimensions. A typical dimension can be the textual structure with scopes like “chapter”, “section”, “paragraph” and “sentence”. Inside a dimension the scopes are organized in a hierarchy, e.g. a chapter contains several sections, which again contains multiple paragraphs and which again have multiple sentences. There is no overlap between scopes inside a dimension, only containment.

There might be multiple instances of the same dimension allowing two overlapping scopes of the same type.

### DETAILED DESCRIPTION

The index of the present invention enables fast execution of a set of query types in combination with regular free text search.

### 5.1 Queries

Various types of queries shall now be discussed in more detail. They may be queries that apply to tokens within a scope, queries for structural relationship between scopes, or queries for scopes overlapping other scopes.

### 5.1.2 Containment Queries

These are queries asking for tokens within a specific scope, for example finding the word “stones” within a “BandName” scope. There might be several tokens in the same query, for example finding all documents with a “BandName” scope containing both “rolling” and “stones”. It is also possible to do a phrase search asking for “the rolling” in a “BandName” scope (the word “the” immediately followed by the word “rolling”).

### 5.1.3 Structure Queries

These are queries asking only for the structural relationships between scopes in a document. Examples are finding documents with a specific scope (for example documents with a “BandName” scope), or documents with one specific scope within another specific scope (for example a “BandName” scope within a “Title” scope). Structural containment can be both within the same dimension and between different dimensions.

It is also possible to ask path queries where the query specifies some path pattern. An example is “/document/*/paragraph/sentence”, which states that the innermost scope must be “sentence”, immediately contained within a “paragraph” scope, which again at some arbitrary depth is contained within a “document” scope. The path “/document/paragraph/sentence”, “/document/section/paragraph/sentence” and “/document/chapter/section/paragraph/sentence” matches this path pattern.

### 5.1.4 Overlapping Queries

These are queries are structural queries which only are possible on scopes from different dimensions. Overlapping queries are queries looking for scopes which overlap another scope like finding “BandName” scopes split over two different pages (“Page” scopes).

All these query types can be combined with regular free text queries in the same query.

### 5.2 Relevancy

This invention can be used to improve relevancy scoring of query results.
Some scopes can be more important than others and documents with terms within those scopes can be boosted.
If two query terms are within the same scope, they are related somehow and can be boosted. The smaller the scope is, the more related they probably are and therefore can be boosted higher.

### 5.3 Encoding

Two inverted indexes are used to index the information. One index is the text index which indexes text tokens. The other index is the scope index which indexes the scopes.

An inverted index maps a key to a list of occurrences of this key in a collection of documents or records. It consists of two major parts, a directory and a postings file.
The directory can be a B-tree, hash map, linear array or any structure that makes it possible to look up a possible key and return a record of values. For this invention we need it to store the position into the posting file where a postings list is located and the size of the list. Usually it will also have the number of elements in the posting list and the number of documents the key appears in (used for relevancy calculations) but this is not essential for this invention.
The postings file stores all the postings lists referenced by the directory.

### 5.4 Text Index

A postings list consists of a sequence of entries with identical record layout. The format of the records of the text index is given in Table 1.

TABLE 1
Record format of the text index

| Field name | Description |
|---|---|
| Docld | The document the token is in |
| Position | The position of the token within the document |
| path | The scope the token appears in |

Since a word can be inside scopes in multiple dimensions, there will be one record for each dimension instance.

A postings list in the text index is sorted on increasing DocId, then on Position, then on Path.

FIG. 1 shows an example of a stream of tokens of a document. The tokens are enumerated t1 through t16. There are two dimensions: dimension1 and dimension2. In dimension1 there are three scopes: a, b and c. In dimension2 there is only one scope e. The postings lists for the tokens t1, t2, t3, t6, t11, t13 and t16 are listed in table 2.

TABLE 2
Posting lists for the text index of the document in FIG. 1

Posting lists

| Token | Docid | Position | Path |
|---|---|---|---|
| t1 | 78 | 1 | /e[1] |
| t2 | 78 | 2 | /a[1] |
| | 78 | 2 | /e[1] |
| t3 | 78 | 3 | /a[1]/b[1] |
| | 78 | 3 | /e[1] |
| t6 | 78 | 6 | /a[1]/b[2]/c[1] |
| | 78 | 6 | /e[2] |
| t11 | 78 | 11 | /a[2]/b[1] |
| t13 | 78 | 13 | /a[2]/c[2] |
| t16 | 78 | 16 | / |

The posting list of the text index comprises entries for the parths of each token. The format of the path field is an ordered list of the scopes the token is enclosed in. The Path “/a[1]/b[2]/c[1]” for the token t6 on position 6 means that the token t6 is within a c scope, which is within a b scope, which again is within an a scope.

The number within a bracket ([ ]) is the sequence number of the scope within the encapsulating scope (counted from 1). The c is the first scope within b. The b is the second scope within a. The a is the first scope in the dimension.

The sequence number can be left out if the sequence of a scope is not significant and the scope is unique within the encapsulating scope.

### 5.5 Scope Index

The format of the records in the scope index is given in table 3.

TABLE 3
Record format of the scope index

| Field name | Description |
|---|---|
| Docld | The document the scope is in |
| StartPos | The position of the start (inclusive) of the scope within the |
| | document |
| EndPos | The position of the end (exclusive) of the scope within the |
| | document |
| Path | The path of the scope |

A postings list in the scope index is sorted on increasing DocId, then on StartPos, then on Path.

For the example in FIG. 1 the postings list will be as given in table 4.

TABLE 4
Posting lists for the scope index of the document in FIG. 1

| | Posting lists | | | |
|---|---|---|---|---|
| Scope | Docid | StartPos | EncPos | Path |
| a | 78 | 2 | 9 | /a[1] |
| | 78 | 11 | 15 | /a[1] |
| b | 78 | 3 | 5 | /a[1]/b[1] |
| | 78 | 6 | 9 | /a[1]/b[2] |
| | 78 | 11 | 13 | /a[2]/b[1] |
| c | 78 | 6 | 14 | / |
| | | | | a[1]/b[2]/c[1] |
| | 78 | 13 | 4 | /a[2]/c[2] |
| e | 78 | 1 | 4 | /e[1] |
| | 78 | 6 | 9 | /e[2] |
| | 78 | 9 | 11 | /e[3] |
| | 78 | 14 | 16 | /e[4] |

Similar to table 2, also the posting list for each scope comprises one entry for each path. The scope is of course given by the last element of a path.

The format of the Path field is the same as for the text index. The Path should include the leaf scope itself.

### 5.6 Encoding XML

XML can be encoded using the index described above by using the following rules:
Each XML element becomes a scope (element scope).
Text in the document is tokenized and enumerated from 1. This number is the tokens Position. Tokens in XML attributes are excluded from this sequence.
The StartPos of an element scope is the Position of the first token following the start of the scope.
The EndPos of an element scope is the Position of the first token following the end of the scope.
Attributes are encoded as leaf scopes in the surrounding scope. The name of an attribute scope is the attribute name with a “@” prefix. An attribute scope is not significant. The tokens within an attribute are enumerated from the same position as the surrounding scope.

Assume the following XML text:

<doc>

<para size=22 color=”yellow”

comment=”This is the first paragraph”>

Alpha bravo charlie delta echo foxtrot
golf hotel india juliet.

</para>
<para size=15 color=”red”

comment=”Second paragraph”>

Kilo lima mike november oscar papa
quebec romeo sierra tango.

</para>

</doc>

This is the resulting stream to be indexed:

Scope doc StartPos=1 EndPos=21 Path=/doc[1]
Scope para StartPos=1 EndPos=11 Path=/doc[1]/para[1]
Scope @size StartPos=1 EndPos=2 Path=/doc[1]/para[1]/@size[1]
Token 22 Position=1 Path=/doc[1]/para[1]/@size[1]
Scope @color StartPos=1 EndPos=2 Path=/doc[1]/para[1]/@color[2]
Token yellow Position=1 Path=/doc[1]/para[1]/@color[2]
Scope @comment StartPos=1 EndPos=6 Path=/doc[1]/para[1]/@comment[3]
Token this Position=1 Path=/doc[1]/para[1]/@comment[3]
Token is Position=2 Path=/doc[1]/para[1]/@comment[3]
Token the Position=3 Path=/doc[1]/para[1]/@comment[3]
Token first Position=4 Path=/doc[1]/para[1]/@comment[3]
Token paragraph Position=5 Path=/doc[1]/para[1]/@comment[3]
Token alpha Position=1 Path=/doc[1]/para[1]
Token bravo Position=2 Path=/doc[1]/para[1]
Token charlie Position=3 Path=/doc[1]/para[1]
Token delta Position=4 Path=/doc[1]/para[1]
Token echo Position=5 Path=/doc[1]/para[1]
Token foxtrot Position=6 Path=/doc[1]/para[1]
Token golf Position=7 Path=/doc[1]/para[1]
Token hotel Position=8 Path=/doc[1]/para[1]
Token india Position=9 Path=/doc[1]/para[1]
Token juliet Position=10 Path=/doc[1]/para[1]
Scope para StartPos=11 EndPos=21 Path=/doc[1]/para[2]
Scope @size StartPos=11 EndPos=12 Path=/doc[1]/para[2]/@size[1]
Token 15 Position=11 Path=/doc[1]/para[2]/@size[1]
Scope @color StartPos=11 EndPos=12 Path=/doc[1]/para[2]/@color[2]
Token red Position=11 Path=/doc[1]/para[2]/@color[2]
Scope @comment StartPos=11 EndPos=13 Path=/doc[1]/para[2]/@comment[3]
Token second Position=11 Path=/doc[1]/para[2]/@comment[3]
Token paragraph Position=12 Path=/doc[1]/para[2]/@comment[3]
Token kilo Position=11 Path=/doc[1]/para[2]
Token lima Position=12 Path=/doc[1]/para[2]
Token mike Position=13 Path=/doc[1]/para[2]
Token november Position=14 Path=/doc[1]/para[2]
Token oscar Position=15 Path=/doc[1]/para[2]
Token papa Position=16 Path=/doc[1]/para[2]
Token quebec Position=17 Path=/doc[1]/para[2]
Token romeo Position=18 Path=/doc[1]/para[2]
Token sierra Position=19 Path=/doc[1]/para[2]
Token tango Position=20 Path=/doc[1]/para[2]

### 5.7 Encoding and Compression

Compression can be used to significantly reduce the size of the inverted indexes. The reduced size will lower the required disk space, but more importantly reduce the data needed to be written to or read from disk during indexing and query processing and therefore improving performance.

Each posting list can be encoded as a sequence of integers. The sequence is written and read sequentially from the start of the list. The integers can be encoded with a varying number of bits depending on the frequency of the integer.

The encoding proposed here is based on making the integers as small as possible.

There is a large range of well known compression techniques which uses this property to reduce the storage requirements.

The DocId is encoded as the difference from the DocId in the previous row.

For the text index, Position is encoded as the difference from the Position in the previous row if the DocIds are the same. If it is a new DocId, Position is encoded as the number itself.

The StartPos for the scope index is encoded just like Position in the text index. EndPos is encoded as the difference from the StartPos in the same row.

Directory compression is used to compress the Path. To facilitate this there are three directories: the dimension directory, the path directory and the scope directory.

The dimension directory encodes each dimension into a unique integer, as shown in table 5 below.

TABLE 5
Dimension encoding

| Field | Type | Description |
|---|---|---|
| DimensionId | Integer | A unique integer identifying the dimension |
| Dimension | String | The textual name of the dimension |

The dimension directory must contain one default entry for tokens outside any scopes.

The scope directory encodes each scope into a unique integer. A scope is significant if the order the scope occurs in is used in queries or if the scope can occur multiple times within an immediately surrounding scope. The scope encoding is shown in table 6 below.

TABLE 6
Scope encoding

| Field | Type | Description |
|---|---|---|
| ScopeId | Integer | A unique integer identifying the scope |
| Dimension | Integer | The dimension the scope is within |
| ScopeName | String | The textual name of the scope |
| IsSignificant | Boolean | Set to true if the scope is significant |

The path directory encodes the path (without the sequence numbers) into a unique integer. The directory is encoded with the following fields as shown in table 7 below.

TABLE 7
Path encoding

| Field | Type | Description |
|---|---|---|
| PathId | Integer | A unique integer identifying the path |
| Dimension | Integer | The dimension the path is within |
| Path | Integer[ ] | A list of the scopes the path is composed |
| | | of. The list is encoded as an integer array |
| | | containing ScopeId's from the scope |
| | | directory |
| Pathlength | Integer | The number of scopes in the path |
| SequenceMap | Integer[ ] | A map of sequence numbers for |
| | | significant scopes. Represented |
| | | as an integer array with the same |
| | | number of elements as Path. If the |
| | | value is −1 the scope is not significant. |
| | | The significant scopes are enumerated |
| | | from left starting with 0 |
| SequenceLength | Integer | The number of sequence numbers for |
| | | significant scopes. Corresponds to the |
| | | number of elements different from −1 |
| | | in the SequenceMap |
| Boost | Double | A floating point number with the |
| | | relevancy book factor of this path |

To be able to encode tokens outside any scopes, the path directory must contain one default entry. For the default entry Dimension should be set to the default dimension and Path and SequenceMap should be empty. PathLength and SequenceLength are set to 0.

The directories are shared among the dimensions.

The directories for the sample data in FIG. 1 are given in tables 8, 9 and 10 below.

TABLE 8
Dimension directory

| DimensionId | DimensionName |
|---|---|
| 1 | <default> |
| 2 | dimension2 |
| 3 | dimension1 |

TABLE 9
Scope directory

| ScopeId | Dimension | ScopeName | IsSignificant |
|---|---|---|---|
| 1 | 2 | e | true |
| 2 | 3 | a | true |
| 3 | 3 | b | true |
| 4 | 3 | c | false |

TABLE 10
Path directory

| | | | Path | Sequence | Sequence | |
|---|---|---|---|---|---|---|
| PathId | Dimensions | Path | Length | Map | Length | Boost |
| 1 | 1 | [ ] | 0 | [ ] | 0 | 1.0 |
| 2 | 3 | [1] | 1 | [0] | 1 | 1.0 |
| 3 | 2 | [2] | 1 | [0] | 1 | 1.0 |
| 4 | 2 | [2, 3] | 2 | [0, 1] | 2 | 1.5 |
| 5 | 2 | [2, 3, 4] | 3 | [0, 1, −1] | 2 | 1.5 |
| 6 | 2 | [2, 4] | 2 | [0, −1] | 1 | 1.0 |

In this example the scope b has been given an extra boost for higher relevancy scores and defined that c is not significant.

In the compressed posting lists Path is encoded as the corresponding PathId followed by the sequence numbers of significant scopes. By ordering the path directory with the most frequent path first and by decreasing frequency, the most frequent PathId's will have the smallest numbers.

The sequence numbers of significant paths are encoded sequentially in the same order as in the path.

The posting lists in the text index of the example in FIG. 1 then become:

| | |
|---|---|
| t1: | 78, 1, 2, 1 |
| t2: | 78, 2, 3, 1, |
| | 0, 0, 2, 1 |
| t3: | 78, 3, 4, 1, 1, |
| | 0, 0, 2, 1 |
| t6: | 78, 6, 5, 1, 2 |
| | 0, 0, 2, 2 |
| t11: | 78, 11, 4, 2, 1 |
| t13: | 78, 13, 6, 2 |
| t16: | 78, 16, 1 |

The posting lists in the scope index of the example in FIG. 1 then become:

| | |
|---|---|
| a: | 78, 2, 7, 1, 1 |
| | 0, 9, 4, 1, 1 |
| b: | 78, 3, 2, 3, 1, 1, |
| | 0, 3, 3, 3, 1, 2, |
| | 0, 5, 2, 3, 2, 1 |
| c: | 78, 6, 2, 5, 1, 2, |
| | 0, 7, 1, 6, 2 |
| e: | 78, 1, 3, 2, 1, |
| | 0, 5, 3, 2, 2, |
| | 0, 3, 2, 2, 3, |
| | 0, 5, 2, 2, 4 |

These sequences can then be encoded using one of the well known compression techniques like Huffman, Rice or vByte encoding. Rice and vByte can be used without prior knowledge of the distribution of numbers (except the fact that smaller numbers are more frequent than larger ones). Huffman coding provides best compression but requires knowledge of the distribution in advance.

An alternative way of encoding the significant sequence numbers is to use dictionary coding. The most frequent lists of sequence numbers are enumerated and represented with the corresponding unique id number. Less frequent lists are encoded with an unused id number followed by the list of the sequence numbers (just like above).

Instead of encoding the posting list with full rows every time it is possible to use run length encoding for the DocId. The first time a DocId occurs, the number of rows it is repeated in is appended immediately after the DocId. For the following rows the DocId is left out. The posting lists in the scope index of the example in FIG. 1 then become:

The posting lists in the scope index of the example in FIG. 1 then become:

| | |
|---|---|
| a: | 78, 2, |
| | 2, 7, 1, 1 |
| | 9, 4, 1, 1 |
| b: | 78, 3, |
| | 3, 2, 3, 1, 1, |
| | 3, 3, 3, 1, 2, |
| | 5, 2, 3, 2, 1 |
| c: | 78, 2, |
| | 6, 2, 5, 1, 2, |
| | 7, 1, 6, 2 |
| e: | 78, 4, |
| | 1, 3, 2, 1, |
| | 5, 3, 2, 2, |
| | 3, 2, 2, 3, |
| | 5, 2, 2, 4 |

This scheme is more space efficient if tokens are repeated multiple times in each document.

### 5.8 Construction

The inverted index described above should be constructed just like traditional inverted indexes with the exception of appending the Path column to every occurrence entry.

During construction of the indexes documents will be scanned sequentially. Tokens and scopes are extracted and added to the index. When a token is added, information about position, dimension and the path of the encapsulating scope is provided. When a scope is added, information about start position, end position and the path of the scope itself is provided.

FIG. 2 shows an overview of the inverted index according to the present invention and embodied as a dual index with a text index and a Scope index which both are inverted indexes, each with a lexicon and posting file. The path field in the posting files references entries in the Path directory. The Path directory contains entries with a list of scopes listed in the Scope directory. Scopes and paths belong to a dimension listed in the dimension directory. For most applications, the number of unique paths, scopes and dimensions are small and the three directories can be cached in a main memory of a computer system on which the index is implemented.

### 5.9 Dictionaries

To be able to encode the Path column it is necessary to have the dictionaries outlined above (dimension dictionary, scope dictionary and path dictionary). These dictionaries can either be available in advance before indexing the data (static dictionaries) or constructed on the fly (dynamic dictionaries).

### 5.9.1 Static Dictionaries

The dictionaries can be constructed fully in advance if the complete schema of the data is known:
All dimensions
All scopes, which dimension they belong to and if they are significant
All legal paths of the scopes

Without prior schema knowledge, the dictionaries can be constructed by doing a complete scan through the entire document collection. Every time a new dimension, scope or path is encountered, the entity is added to the corresponding dictionary. The DimensionId and ScopeId can be assigned sequentially as they arrive while the PathId should not be assigned before all documents have been processed.

During the scan, the number of times every path occurs should be counted. After the scan the paths should be enumerated based on decreasing count. The most frequent path should get the least PathId. This will improve compression rate. The path frequencies can also be used to make an optimal Huffman encoding of the PathIds.

Without prior knowledge of the schema it will not be possible to know if a scope is significant or not and therefore every new scope must be marked significant.

### 5.9.2 Dynamic Dictionaries

The dictionaries can also be constructed on the fly while indexing a document collection. When a term or scope is added, the directories are used to encode the Path field. When dimension, scope or path cannot be found in the directories, the entity is added to the corresponding dictionary and a new DimensionId, ScopeId or PathId is assigned.

Obviously, infrequent paths can get small PathIds which is not optimal for compression. On the other hand, most of the frequent paths will soon be used and get relatively small identifiers.

Sampling can be used to improve the assignment of PathIds. This is done by sampling a small subset of the documents which contains a representative mix of the various document types. This subset can be scanned and used to create initial dictionaries based on frequency. The most frequent paths should be represented in this subset with relatively the same frequencies as in the full document collection. Some dimensions, scopes and paths will likely not be present, but they will be infrequent and can be added on the fly.

A popular way of constructing inverted indexes is to create smaller inverted index files of the size of some main memory buffer. When the full collection has been processed, the set of small index files are merged together into one large index file.

Each of the small index files can have their own dictionary set and its own encoding. This dictionary set with frequency numbers is written either at the end of an index file or as a separate file. The process of merging together the index files starts with reading the dictionary set and combining the frequencies into a new global dictionary set which will be used to encode the large combined index file.

### 5.10 Retrieval

The present invention also provides a path filter for use with the index of the invention. Path filters and their use shall now be discussed in general term as well as with specific reference to the path filter of the present invention.

Most querying using the path information starts with creating one or more path filters. A path filter is created from a path pattern, which is an expression defining which paths are matching or not. The path pattern can be an XPath expression or a simple wildcard expression. A wildcard expression can be defined as a sequence of scope names separated with “/” symbols. The outermost scope is written first, then the scope immediately contained within it, etc. until it is finished with the innermost scope. Anywhere a scope name can be replaced with a “?” which means that it matches any scope. A “*” replaces any sequence of zero or more scope names. Alternatives can be surrounded by “[” and “]” symbols and separated by commas. Examples:

“/document” matches only the paths with “document” as the root scope and not any
sub-scopes.
“/document/chapter/paragraph/sentence” matches paths with “sentence” as the leaf
scope and “paragraph” as the immediately surrounding scope. The “chapter”
surrounds the “paragraph” while “document” is the root scope.
“/document/?” matches any path of depth 2 with “document” as the root scope, e.g.
“/document/sentence”.
“/document/*” matches any path of depth 1 or higher with “document” as the root
scope, e.g. “/document”, “/document/sentence” or
“/document/chapter/paragraph/sentence”.
“/document/*/sentence” matches any path of depth 2 or higher with “document” as
the root scope and “sentence” as the leaf scope, e.g. “/document/sentence” or
“/document/chapter/paragraph/sentence”.
“/document/[chapter,section]/paragraph” will match the two paths
“/document/chapter/paragraph” and/document/section/paragraph”.

Regular expressions and XPath expressions are other well known expression languages and can be used to express path expressions. These are well known in literature and will not be described further here.

A path filter can be represented as a bit vector with one bit for each path in the path dictionary. The PathId is used as an index into the path filter. A bit set in the bit vector means that the corresponding path in the path directory matches the path expression.

An extended path filter is represented by an integer vector with one integer for each path. If the integer is −1, there is no match for this path. If the number is greater or equal to zero, it states how long prefix of the sequence numbers this path expression matches into the path. For example assume the expression “/document/*/paragraph/*”. Further assume that “chapter” and “paragraph” are significant while “document” is not. The sequence number prefix for the path “/document/chapter/paragraph/sentence” then becomes 2. The sequence number prefix for the path “/document/paragraph/sentence” becomes 1.

The path filter can be constructed in a number of ways. The simplest one is to start with a cleared vector (bit cleared, integer set to −1) and iterate through all paths in the path directory. For each path, the corresponding bit/integer in the vector is set if the path matches the path expression.

For large path directories this can take long time and using index structures can speed up finding the matching paths. There are several well known index structures that can be used. One way is to maintain a suffix tree or a suffix array over all paths in a path directory. Another is to set up an inverted index over all scopes and look up all possible matching paths by combining the posting lists for each scope name in the path expression. This is prior art and not described further here. Common for these indexes is that for each path that is found to match the path expression, the corresponding bit/integer is set in the path filter.

The path filter defined here can then be used in a wide range of queries.

### 5.10.1 Single Term Containment Query

This is a query of the form “find all documents with a given word within a path specified with a path expression”, e.g. find all documents with “John” within a “/*/name” path.

Such a query is evaluated by first creating a path filter for the path expression. Then the posting list of occurrences for the word is retrieved from the text index. The next step is to iterate through the posting list and for each posting match the PathId with the bit in the path filter. If the bit is set, the DocId is appended to the set of matching documents. When all postings have been inspected, the set of matching documents represents the result of the query.

### 5.10.2 Multi Term and Containment Query

Such a query is evaluated by first creating an extended path filter for the path expression. Then the posting lists of occurrences for all the words are retrieved from the text index. Then iterate through the posting lists in parallel and synchronized with respect to the DocId. If all posting lists have the same DocId and at the same time matches the path filter for at least one PathId, the sequence numbers must be checked. If the sequence numbers for each of the posting lists match up to the index given by the integer in the path filter, the DocId can be added to the set of matching documents.

Queries for a text phrase within a given scope can be executed the same way but in addition also checking that the Position values are correct relative to each other.

### 5.10.3 Structure Query

This is a query of the form “find all documents with a specific scope present within a path specified with a path expression”, e.g. find all document with a “name” scope within a “/*/title/*” path.

This is evaluated identical to a single term containment query but looking up in the scope index instead of the text index.

We claim:

1. An inverted index for contextual search in a collection of documents, wherein contextual search is applied for retrieving one or more tokens of a document as well as the context wherein the one or more tokens occurs, the context being any identifiable structure of a document; wherein any specific single context forms a scope of the document; wherein the inverted index at least comprises a subindex in the form of a text index of text tokens; wherein the text index comprises records formatted with a first field identifying the document wherein the token is located, a second field for the position of the token in this document, and a third field for the path of the scope enclosing the token, and wherein said records constitute a posting list of the text index, such that the index comprises information of the paths for every occurrence of the tokens and hence enables a contextual search.

2. An index according to claim 1,
characterized in that the last scope in a path in the posting list of the text index is the scope enclosing the token.

3. An index according to claim 1,
characterized in that the posting list for token in a document is sorted initially on increasing document identification, then on position and finally on path.

4. An index according to claim 1,
characterized in that it is a dual index comprising in addition to the text index another subindex in the form of a scope index of scopes wherein the text occurs, and that the scope index comprises records formatted with a first field for identifying the document wherein the scope is located, a second field for the start position of the scope in that document, a third field for end position of the scope in this document and a fourth field for the path of the scope and always including the scope itself, with said records constituting a posting list of the scope index.

5. An index according to claim 4,
characterized in that a path in a record in the posting list for respectively the text index and the scope index, is an ordered list of nested scopes and their dimensions.

6. An index according to claim 4,
characterized in that the posting list of the scope index is sorted initially on increasing document identification, then on start position, and finally on path.

7. An index according to claim 4,
characterized in that the path of the scope index includes the scope itself as the final scope of the path.

8. An index according to claim 4,
characterized comprising indexed multiple dimensions of scopes, with one occurrence for each dimension.

9. An index according to claim 4,
characterized in comprising indexed text tokens for performing a free text search, and/or indexed scope names for searching with structured search queries.

10. An index according to claim 4,
characterized in that the paths are encoded with a path directory.

11. An index according to claim 4,
characterized in that only significant sequence numbers are encoded.

12. A path filter for use with the inverted index for contextual search, wherein the path filter comprises a path pattern in the form of expressions defining which paths that match or do not match a search query.

13. A path filter according to claim 12,
characterized in being based on a path directory.

14. A path filter according to claim 12,
characterized in being adapted for matching paths encoded in the index, whereby documents with a term (token) within a specified path expression or with multiple terms within one and the same specified path expression can be found.

15. A path filter according to claim 12,
characterized in being a simple path filter represented as a bit vector with one bit for each path in the path directory.

16. A path filter according to claim 12,
characterized in being an extended path filter represented as an integer vector with one integer for each path in the path directory.
